(19) United States
(12) Patent Application Publication
(10) Pub. No.: US 2019/0147029 A1
(43) Pub. Date: May 16, 2019

(54) METHOD AND SYSTEM FOR GENERATING CONVERSATIONAL USER INTERFACE

(71) Applicant: INSTITUTE FOR INFORMATION INDUSTRY, Taipei City (TW)

(72) Inventors: Yu-Shian CHIU, Taoyuan City (TW); Wei-Jen YANG, Kaohsiung City (TW)

(73) Assignee: INSTITUTE FOR INFORMATION INDUSTRY, Taipei City (TW)

(21) Appl. No.: 15/829,056

(22) Filed: Dec. 1, 2017

(30) Foreign Application Priority Data
Nov. 15, 2017 (TW) 106139454

(51) Int. Cl. G06F 17/24; G06F 17/27; G06F 3/0481

(52) U.S. Cl. CPC G06F 17/243; G06N 3/08; G06F 3/0481; G06F 17/271

(57) ABSTRACT

A method for generating a conversational user interface is provided. The method is executed by a processor to perform the following steps. Extract the content of a webpage. Obtain a first form in the webpage. Obtain multiple first fields according to the first form. Create a first slot filling model based on the multiple first fields. Generate a conversational user interface. The processor is configured to use the first slot filling model to determine data required by the first fields, and obtain data that can be filled in the first fields according to an input dialogue data to fill in the first fields.

This application claims the benefit of Taiwan application Serial No. 106139454, filed Nov. 15, 2017, the disclosure of which is incorporated by reference herein in its entirety.

### TECHNICAL FIELD

The disclosure relates in general to a conversational user interface, and more particularly to a method and a system for generating the conversional user interface automatically from a webpage.

### BACKGROUND

As the network grows enormously nowadays, corporations or service providers can send information and interact with users via webpages or mobile apps. When users face a graphical interface such as a webpage, they need to explore the page themselves to find the information they need. With the rapid development of computer technology, in order to provide a better user experience, a virtual assistant can be used as a communication channel to help users quickly get the information they need from the webpage, such as querying accommodation information, querying flight schedules, ordering movie tickets, buying and selling stocks, online shopping, financial management and investment, and so on. The virtual assistant and the user can interactive in real-time. The virtual assistant is for example a conversational user interface (CUI), which allows the user to obtain the desired result by simply inputting natural language dialogue. However, developing a service-specific conversational user interface takes a lot of time and effort, and has to be produced one by one. Also, whenever a new service or webpage appears, designers must spend time understanding the new service or the webpage system architecture to accomplish the corresponding conversational user interface. Therefore, how to quickly create a conversational user interface is one of the issues that the industry is now committed to.

### SUMMARY

The disclosure is directed to a method and a system for generating a conversational user interface that automatically generate the conversational user interface from an input webpage, greatly reducing the amount of time required for developing a new conversational user interface.

According to one embodiment, a method for generating a conversational user interface is provided. The method is executed by a processor to perform the following steps. Extract the content of a webpage by the processor. Obtain a first form in the webpage by the processor. Obtain multiple first fields according to the first form by the processor. Create a first slot filling model based on the multiple first fields by the processor. Generate the conversational user interface by the processor. The processor is configured to use the first slot filling model to determine data required by the first fields, and obtain data that can be filled in the first fields according to an input dialogue data to fill in the first fields.

According to another embodiment, a system for generating a conversational user interface is provided. The system includes a processor to execute the following modules: a webpage extraction module, a webpage analysis module, and a module building module. The webpage extraction module is configured to extract content of a webpage. The webpage analysis module is configured to obtain a first form in the webpage and obtain multiple first fields according to the first form. The model building module is configured to create a first slot filling model according to the first fields and generate the conversational user interface. The model building module is configured to use the first slot filling model to determine data required by the first fields, and obtain data that can be filled in the first fields according to an input dialogue data to fill in the first fields.

According to still another embodiment, a system for generating a conversational user interface is provided. The system includes a processor and a storage device. The processor can execute multiple computer program modules. The storage device stores computer program modules that can be executed by the processor. The processor performs the following steps when executing the computer program modules: extracting content of a webpage, obtaining a first form in the webpage, obtaining multiple first fields according to the first form, creating a first slot filling model according to the first fields, and generating the conversational user interface. The processor is configured to use the first slot filling model to determine data required by the first fields, and obtain data that can be filled in the first fields according to an input dialogue data to fill in the first fields.

### BRIEF DESCRIPTION OF THE DRAWINGS

FIG. 1 shows a flowchart of a method for generating a conversational user interface according to one embodiment of the invention.

FIG. 2 shows a diagram of a system for generating a conversational user interface according to one embodiment of the invention.

FIG. 3 shows a detailed flowchart of a method for generating a conversational user interface from a webpage according to one embodiment on the invention.

FIG. 4 shows a flowchart of updating a task data file according to one embodiment of the invention.

FIG. 5 shows a flowchart illustrating the operation logic of the conversational user interface according to one embodiment of the invention.

FIG. 6 shows a flowchart of filling in the fields according to the slot filling model according to one embodiment of the invention.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

A method and a system for automatically transforming a webpage to a conversational user interface are provided in this disclosure. The conversational user interface referred to in the disclosure is, for example, a dialogue window popped up in a webpage or a chatbot. The chatbot may be built in instant messaging software, such as Facebook messenger, WhatsApp, WeChat, Line, Telegram, Skype, and other instant messaging platforms. The present invention may also be embedded in an app or a webpage. Corporations can provide real-time customer service 24 hours a day via the chatbot, and users can also solve problems quickly via the chatbot.

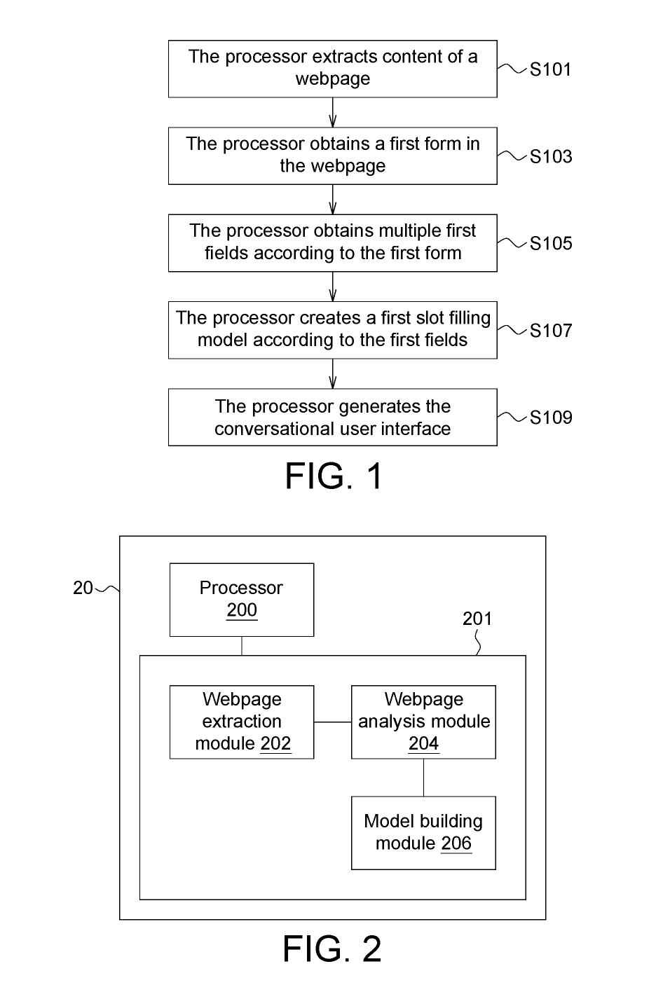

FIG. 1 shows a flowchart of a method for generating a conversational user interface according to one embodiment of the invention. The method shown in FIG. 1 may be executed by a processor. The processor may be a general central processing unit, a microprocessor, or a processor installed in a computer, a mobile device, or a cloud server. The method includes the following steps. Step S101: extract content of a webpage. Step S103: obtain a first form in the webpage. For example, the first from is where the user needs to input data in the webpage. Step S105: obtain multiple first fields according to the first form. Step S107: create a first slot filling model according to the first fields. Step S109: generate the conversational user interface. For example, the first slot filling model defines the data required by the multiple first fields. Each step in FIG. 1 may be executed by the processor. The processor is configured to use the first slot filling model to determine data required by the first fields, and obtain data that can be filled in the first fields according to an input dialogue data to fill in the first fields.

The method shown in FIG. 1 may be implemented as a software program. The software program may be stored in a non-transitory computer readable medium, such as a hard disk, a compact disc, a flash drive, a memory, and other program storage devices. When the processor loads the software program from the non-transitory computer-readable medium, the processor executes the method shown in FIG. 1, transforming a webpage into a conversational user interface. The generated conversational user interface uses the first slot filling model to fill in the data required by the first fields according to the user input dialogue data, and accomplished the task assigned by the user. Since the method shown in FIG. 1 can automatically generate a conversational user interface from a webpage, when a corporation has a new service available online, the corporation only has to provide the corresponding webpage. Then the method proposed in the this disclosure can quickly generate the required conversational user interface from the webpage, saving a lot of time and effort, eliminating the need for human understanding and code writing, drastically reducing the development cost of the conversational user interface, and also increasing the viability in practical applications.

In one embodiment, the system for generating the conversational user interface includes a processor and a program storage device. The processor can execute one or more computer executable instructions. The program storage device stores computer program modules that can be executed by the processor. The processor performs the steps shown in FIG. 1 when executing the computer program modules.

FIG. 2 shows a diagram of a system for generating a conversational user interface according to one embodiment of the invention. The system for generating the conversational user interface 20 includes a processor 200 and a storage device 201. The storage device 201 stores the following modules, which can be executed by the processor 200. A webpage extraction module 202, a webpage analysis module 204, and a module building module 206. The webpage extraction module 202 is configured to extract content of a webpage. The webpage analysis module 204 is configured to obtain a first form in the webpage and obtain multiple first fields according to the first form. The model building module 206 is configured to create a first slot filling model according to the first fields and generate the conversational user interface. The model building module 206 is configured to use the first slot filling model to determine data required by the first fields, and obtain data that can be filled in the first fields according to an input dialogue data to fill in the first fields. For example, the model building module 206 uses the first slot filling model to analyze content of the input dialogue data to obtain at least one word, and compare the at least one word with the rule (such as type, attribute, and/or option) of each first field to fill in the first fields.

The system for generating the conversational user interface 20 shown in FIG. 2 is one embodiment for carrying out the method shown in FIG. 1. In another embodiment, the webpage extraction module 202, the webpage analysis module 204, and the module building module 206 may be individually implemented as a software unit or a hardware unit. Alternatively, part of the modules may be jointly implemented as software and part of the modules may be jointly implemented as hardware. The software implemented modules may be loaded by the processor to perform the corresponding functions. The hardware implemented modules may be implemented as a microcontroller, a microprocessor, a digital signal processor, an application specific integrated circuit (ASIC), a digital logic circuit, or a field programmable gate array (FPGA).

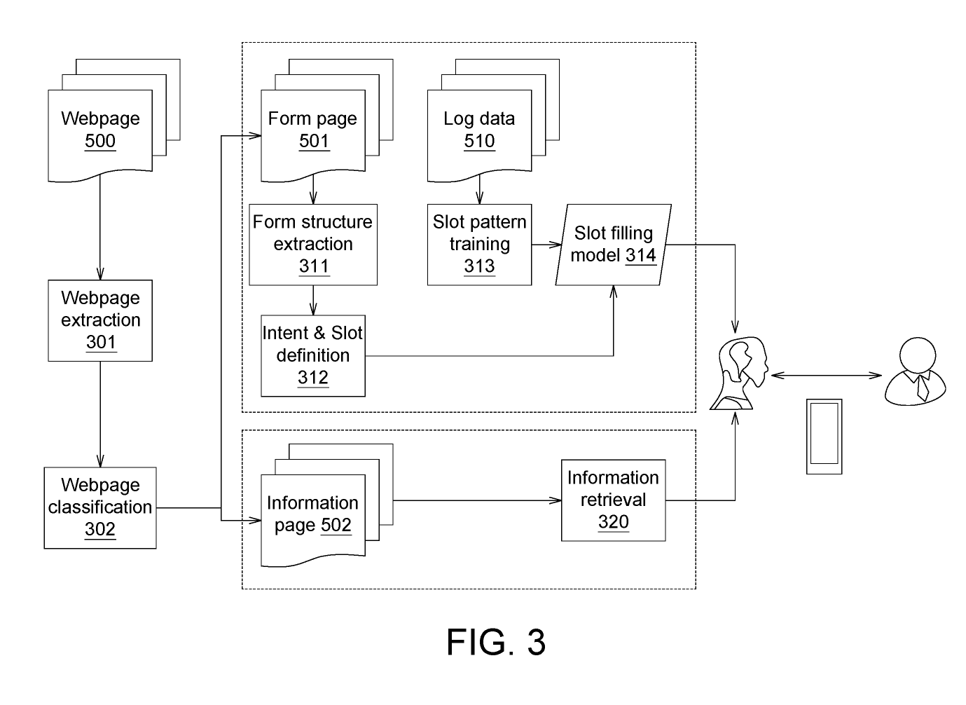

FIG. 3 shows a detailed flowchart of a method for generating a conversational user interface from a webpage according to one embodiment on the invention. The input data is the webpage 500. First the step 301 webpage extraction is executed. The step 301 is for example corresponding to the step S101 in FIG. 1, which may be performed by the webpage extraction module 202. One embodiment of the webpage extraction module 202 is a web crawler. Next the step 302 webpage classification is executed, which classifies the extracted webpage 500 into a form page 501 and an information page 502. The form page 501 is task oriented, which usually includes some information that requires the user to fill in. Typical applications include booking tickets and room reservations. The information page 502 relates to information retrieval, which usually includes descriptive information. Typical applications include laws, regulations, frequently asked questions (FAQs), and so on. For the information page 502, the step 320 may be performed to retrieve data for keyword extraction and data indexing.

The following describes the processing procedure for the task oriented part. For the form page 501, the step 311 is first executed to extract the form structure. The form described herein is for example corresponding to the first form referred in the step S103 shown in FIG. 1. In one embodiment, the step 311 parses a structured language that describes the webpage 500 to extract the “form” and the required “input” in the webpage. The structured language that describes the webpage 500 is for example hypertext markup language (html). The step 311 may search the keywords “form” and “input” in the html file to identify the form location, thus obtaining the form name and the input name. The structured language that describes the webpage 500 may also be a file format that has structural characteristics such as xml or JSON, from which form information may also be extracted. In this specification, the html language will be used as an example. However, the present invention is not limited to parsing the html language.

In one embodiment, the step 311 further includes obtaining a rule corresponding to each field (for example, the first field in the step S105 in FIG. 1) according to the form (for example, the first form in the step S105 in FIG. 1). The rule includes at least one of the following: a type, an attribute, and an option. The rule represents the format, type, range of values, or text pattern that the user input conforms to. For example, the step 311 searches the keywords “type”, “option”, “max”, “min”, etc. corresponding to each input in the html file to obtain the rule of each field. In one embodiment, the webpage analysis module 204 is configured to analyze each field according to the webpage to determine at least one of the type, the attribute, and the option corresponding to each field, so as to create the rule of each field according to the analysis result. For example, the rule of each field may state the condition under which the input data conforms to the type, the condition under which the input data conforms to the attribute, and/or the condition under which the input data conforms to the option.

Based on the form obtained in the step 311, the step 312 may be followed to define the slot and the intent. The slot represents the multiple fields corresponding to the form. The intent represents the user intention. The user intention may be corresponding to the function of the form, such as booking tickets and room reservations. For example, the step 312 may use the form title as the intent, and use the input part of the form as the slot.

One example is given below to illustrate the execution result of the steps 311 and 312. These two steps may be performed by the web analysis module 204 as shown in FIG. 2. The example used herein is a webpage for booking movie tickets. The form can be obtained after parsing the webpage html file in the step 311. The form may be represented as the data structure shown in Table 1 below.

TABLE 1
Form title: book ticket

| Input Name | Type | Attribute | Option |
|---|---|---|---|
| Email | Email | | |
| Movie title | String | | Movie A |
| | | | Movie B |
| | | | Movie C |
| Theater name | String | | Theater P |
| | | | Theater Q |
| | | | Theater R |
| Date | Date | | 2017 Aug. 22 |
| | | | 2017 Aug. 23 |
| | | | 2017 Aug. 24 |
| Show time | Time | | 11:30 |
| | | | 13:00 |
| | | | 14:30 |
| | | | 16:00 |
| | | | 17:30 |
| Number of people | Number | Max: 10, Min: 1 | |

In one embodiment, the step 311 may convert the form obtained from the webpage into another structured data format, such as angular schema form, which describes the content in Table 1 in another format.

Based on Table 1, the step 312 may define the function of the form (corresponding to the form tile) as “book ticket”, and define the multiple slots of the form (corresponding to the input name) as including “email”, “movie title”, “theater name”, “date”, “show time”, and “number of people”.

In one embodiment, the rule of each field further includes a syntax. The syntax may be used to indicate the textual syntax for the input data. For example, the syntax may use regular expression. However, the invention is not limited thereto. Other patterns that represent textual syntax may also be used. In one embodiment, the syntax may be established according to at least one of the type, the attribute, and the option. For example, the regular expression ̂[1-10]$ could be used if the condition under which the input data conforms to the attribute is a numerical range from 1 to 10. In another example, if the condition under which the input data conforms to the type is date, the regular expression corresponding to the data format could be established.

In one embodiment, the system for generating the conversational user interface 20 further includes a syntax training module. The syntax training module may be implemented by software or hardware, such as a processor. The syntax training module is configured to create the rule by training log data. The log data used here is related to accessing the form. As shown in FIG. 3, the step 313 slot pattern training may read the log data 510 and create the rule by machine learning (such as neural network). Continuing with the aforementioned movie ticket webpage example, the log data 510 may include multiple past ticket booking records. As such, multiple strings that have been filled in the field “Email” may be obtained from the log data 510. The step 313 may establish the textual syntax that these strings have in common via machine learning, thus creating the rule of the field “Email”, which may be represented by a regular expression for example.

An example that the rule of each field includes the syntax is shown in Table 2. Table 2 adds a column for the syntax as compared to Table 1.

TABLE 2
Form title: book ticket

| Input | | | | |
|---|---|---|---|---|
| Name | Type | Attribute | Option | Syntax |
| Email | Email | | | \hat{ }[\w-\.]+@([\w-] |
| | | | | +\.)+[\w-]{2,4}$ |
| Movie | String | | Movie A | |
| title | | | Movie B | |
| | | | Movie C | |
| Theater | String | | Theater P | |
| name | | | Theater Q | |
| | | | Theater R | |
| Date | Date | | 2017 Aug. 22 | /\hat{ }[0-9]{4}-(0[1-9] |
| | | | 2017 Aug. 23 | \|1[0-2])-(0[1-9]\|[1-2] |
| | | | 2017 Aug. 24 | [0-9]\|3[0-1])$/ |
| Show time | Time | | 11:30 | |
| | | | 13:00 | |
| | | | 14:30 | |
| | | | 16:00 | |
| | | | 17:30 | |
| Number of | Number | Max: 10, | | \hat{ }[1-10]$ |
| people | | Min: 1 | | |

After defining the intent and the slot in step 312 and slot pattern training in step 313, the model building module 206 shown in FIG. 2 may create the slot filling model 314 accordingly. Based on the slot filling model 314 created from the form page 501 and the data index established from the information page 502 in the step 320, a chatbot corresponding the webpage 500 may be accomplished, which can interact with the users through conversations.

The step 313 slot pattern training may be optionally executed. The slot filling model 314 may be created directly from the slot defined in the step 312 without training the log data 510. For example, in certain scenarios, the log data 510 accessing the form may not be provided due to privacy reasons, or the quantity of the log data 510 is not sufficient when a new service of a corporation is just online.

In one embodiment, a determination criterion may be formulated according to at least one of the type, the attribute, and the option of the rule of each field to determine whether or not the step 313 is executed for the corresponding fields. For example, if the type is a string and the option has values (such as “movie title” in Table 2), the values of the option may be directly used as the basis for comparison without performing the step 313. If the type is a number and the attribute has a limitation (such as “number of people” in Table 2), the attribute may be directly converted to the syntax without performing the step 313. The determination criterion disclosed herein is just exemplary rather than limiting the invention.

For the rule of each field, part of the rule may need to be updated, and part of the rule may be fixed. Refer to the movie ticket example shown in Table 2, the rule for the field “Email” and the rule for the field “number of people” are fixed, while the rule for the field “movie title” and the rule for the field “date” may change every day. One possible solution is to execute the method shown in FIG. 1 or FIG. 3 again for the webpage 500 updated every day to generate a conversational user interface corresponding to the updated webpage. However, this approach requires the program code for a new conversational user interface to be re-generated every day, which may cause inconvenient management problem for the corporation, and may also prohibit the chance for further customized modification on the generated conversational user interface.

Therefore in one embodiment, the system for generating the conversational user interface 20 also includes a data update module. The data update module may be implemented as software or hardware, such as a processor. The data update module is configured to extract the webpage again at a scheduled time (such as a fixed time every day, every Wednesday, or the first day of every month) to find out which part of the form is continuously updated, and determine an update section of the rule (including the type, the attribute, the option, the syntax) accordingly. The data update module is also configured to store the update section of the rule in a data file. As such, even if the webpage is updated every day, the method provided in the present invention needs only to update the data file and read the data file, eliminating the need to re-execute the method for generating the conversational user interface as shown in FIG. 1 or FIG. 3. There is no specific format limitation for this data file. Also the number of the data files is not limited. For example, there may be two or more data files, each corresponding to different fields. In the following description, a task data file will be used as an example for this data file.

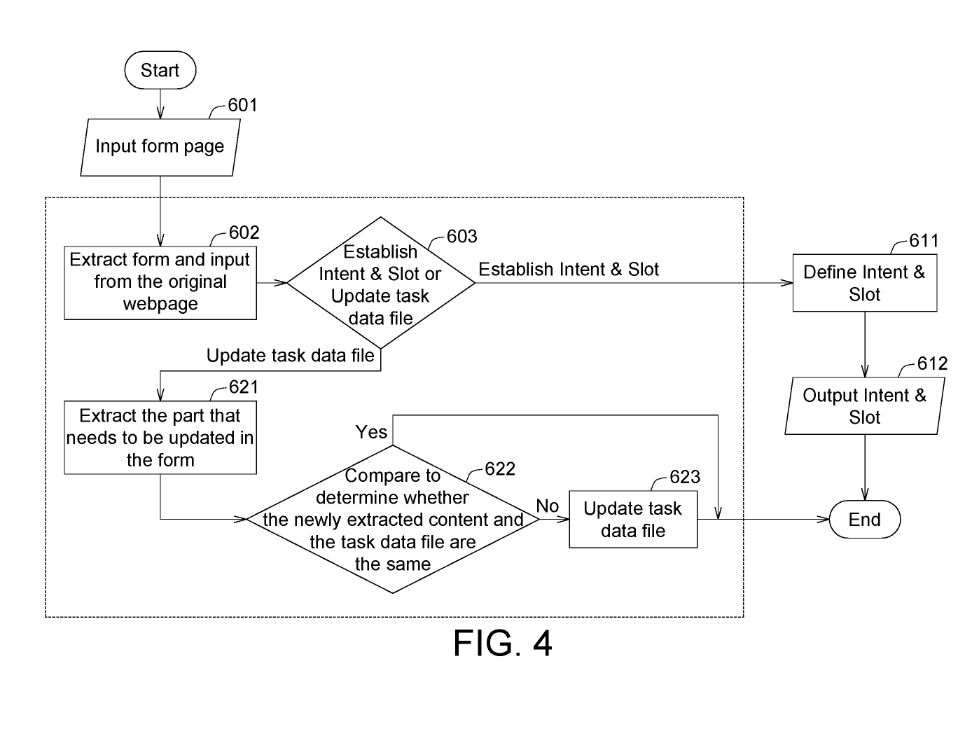

FIG. 4 shows a flowchart of updating a task data file according to one embodiment of the invention. The input data is the input form page 601. The step 602 extracts form and input from the original webpage, similar to the step 311 shown in FIG. 3, and thus is not repeated herein. The step 603 determines whether the current execution is to establish intent and slot or to update the task data file. If the current execution is to establish intent and slot, proceed to step 611 to define intent and slot, and then generate the output intent and slot 612. The step 611 is similar to the step 312 shown in FIG. 3. If the determination result of step 603 is to update the task data file, proceed to step 621 to extract the part that needs to be updated in the form (such as the option of the field “movie title”). Step 622 is then executed to compare to determine whether the newly extracted content and the current task data file are the same. If not, proceed to step 623 to update the task data file. Write the newly extracted content to the task data file. If the determination result of the step 622 is yes, skip the step 623. According to the method shown in FIG.

4, the intent and slot of the form can be defined, and the task data file corresponding to the webpage update information can be created.

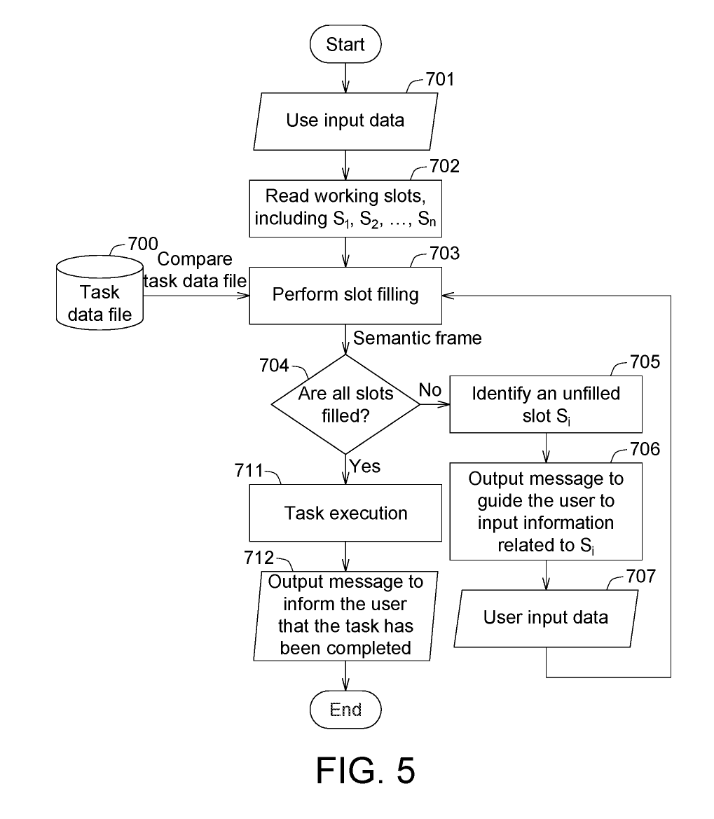

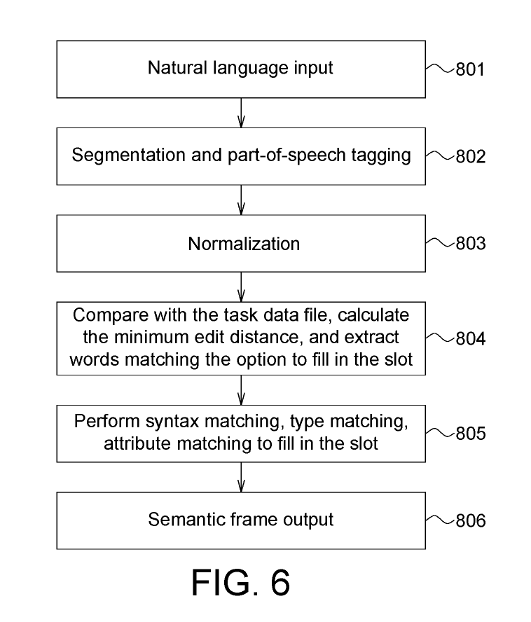

FIG. 5 shows a flowchart illustrating the operation logic of the conversational user interface according to one embodiment of the invention. The source input data is the user input data 701. The user input data 701 may be natural language dialogue data, such as “Hi”, “I want to watch a movie today”, “I plan to watch movie B at theater Q at 3 this afternoon”, and so on. The step 702 reads working slots, including S₁, S₂, . . . , Sₙ, such as Email, movie title, theater name, date, show time, number of people shown in Table 2. Step 703 utilizes the already built slot filling model to fill the required data in the multiple slots. The step 703 may also be referred as slot filling. In one embodiment, because each field has a corresponding rule, the step 703 may identify which slot is to be filled by the current user input data through checking the rule of each field. In one embodiment, the step 703 may be performed by the model building module 206 to read the task data file 700, compare the task data file 700, and then fill in each field. The detailed description about the step 703 may be referred in FIG. 6.

The step 704 determines whether all the slots have been already filled. If not (for example, currently only date is known), step 705 identifies an unfilled slot Sᵢ (for example, movie title). Step 706 outputs a message to guide the user to input information related to the slot Sᵢ. The output message may also include the option corresponding to the slot Sᵢ. For example, the output message may be “Which movie do you want to watch (Movie A/Movie B/Movie C)?” After receiving the user input data 707, the procedure goes back to the step 703 to perform slot filling. In one embodiment, the step 705 may arrange a priority order for the multiple slots. From the currently empty slots, the slot having the highest priority is selected to ask the user first.

If the step 704 determines that all the slots are filled, proceed to step 711 for task execution. Take the movie ticket booking webpage for example, the step 711 may send the collected movie booking information to the website corresponding to the booking webpage to complete the booking task. There may be several implementations for the task execution in the step 711. Examples for task execution include sending a request to the website, calling (or executing) an application programing interface (API) of the website according to the webpage and the data in the fields, sending to the back-end server by form delivery or calling service, and any other means that can transmit the content in the filled slots to the back-end server. Finally an output message 712 may be displayed to inform the user that the task has been completed. The message 712 sent to the user may be a text message (such as “The following is your booking information: . . . ”), or a message obtained by capturing information returned from the website, which may include text, images, and hyperlinks.

In one embodiment, after obtaining the data that can be filled in the fields, a confirmation message may be displayed on a display device before task execution in the step 711. For example, the data currently filled in the slots may be presented on a phone screen or a computer screen in complete sentences so that the user can confirm whether the task to be executed is correct or not, that is, whether the data filled in each slot is correct or not. If it is not correct, the steps 702 to 706 may be re-executed to fill in the slots again. After the confirmation message is confirmed, the step 711 may be performed, such as sending the request to the website or generating a corresponding API to be sent to the website.

In one embodiment, the slot filling model used in the step 703 is configured to analyze content of the input dialogue data to obtain at least one word, and compare the one or more words obtained from the input dialogue data with the rule of each field to fill in the slots. The related flowchart may be referred in FIG. 6, which shows a flowchart of filling in the fields according to the slot filling model according to one embodiment of the invention.

The step 801 receives the natural language input from the user. The step 802 may perform segmentation and part-of-speech tagging on the natural language input by the user. The step 803 may perform content normalization. For example, when the user inputs “I want to book two movie tickets today”, the step 802 may retrieve multiple words “I”, “want”, “to”, “book”, “two”, “movie ticket”, “today”, and the step 803 normalization may convert the word “today” to “2017-08-23”.

The step 804 may compare with the task data file, calculate the minimum edit distance, and extract words matching the option to fill in the slot. In the above example, the field “date” may be filled in because the term 2017-08-23 matches one of the options of the field “date”. In another example, the user may input “I want to watch the movie xxx”. The movie name xxx input by the user might not be able to match any one of the possible options of the field “move title” due to translation, typing error, misremembering, or other reasons. At this point the minimum edit distance may be calculated to determine one possible option that is closest to xxx and fill in the field “movie title”. In an embodiment where the task data file is not used, the step 804 may skip the step of using the task data file for slot filling.

The step 805 may perform syntax matching, type matching, attribute matching to fill in the slot. In the above example, “2” entered by the used is to be filled in the field “number of people” according to type matching and attribute matching. If the user has entered the email address, the step 805 may also fill in the field “Email” via the syntax matching. After the data that can be filled is filled in the corresponding fields, perform step 806 to output the semantic frame, and then proceed to the step 704 shown in FIG. 5.

The embodiments given above are the cases where there is one form in the webpage. Some webpages may contain two or more forms. For example, the webpage of a travel agency may contain a form for domestic travel and another form for international travel. A house rental webpage may contain a form for tenants and another form for landlords. In one embodiment, the webpage analysis module 204 shown in FIG. 2 is configured to obtain the first form and the second form in the webpage, and obtain the first function corresponding to the first form and multiple first fields, obtain the second function corresponding to the second form and multiple second fields. The function corresponding to the form may be obtained from the form name. The model building module 206 may create a first slot filling model according to the multiple first fields and create a second slot filling model according to the multiple second fields. The method for creating the slot filling model may be referred in FIG. 3.

The conversational user interface generated by the model building module 206 may determine the user intention. For example, the conversional user interface may display multiple buttons on the screen to be selected by the user, or let the user answer questions that have several available options. A corresponding form is then decided according to the obtained user intention. For example, when the user intention is corresponding to the first function, the model building module 206 uses the first slot filling model to obtain data that can be filled in the first fields according to the input dialogue data to fill in the first fields. When the user intention is corresponding to the second function, the model building module 206 uses the second slot filling model to obtain data that can be filled in the second fields according to the input dialogue data to fill in the second fields.

According to the embodiments described above, the method and system for generating the conversational user interface can automatically generate the conversational user interface from an input webpage quickly, reducing the labor cost and time cost required for program development. The rule of each field can be obtained by parsing the webpage. Therefore, when reading dialogue data input by the user, data can be filled in the appropriate fields since each field has a specific rule for comparison. In addition, the rule of each field can be established by training the log data accessing the webpage. The invention also takes into account the situation that the rule of each field may change over time. The part that needs to be updated may be stored in a data file by extracting the webpage again, thus avoiding the need for repeatedly generating a new conversational user interface, which improves the ease of management as well as usage flexibility. The invention is also capable of processing a webpage having multiple forms. The proposed method can first determine the user intention and then decide the corresponding slot filling model to be used.

It will be apparent to those skilled in the art that various modifications and variations can be made to the disclosed embodiments. It is intended that the specification and examples be considered as exemplary only, with a true scope of the disclosure being indicated by the following claims and their equivalents.

1. A method for generating a conversational user interface, executed by a processor to perform the following steps, the method comprising:
extracting content of a webpage by the processor;
obtaining a first form in the webpage by parsing, by the processor, a structured language that describes the webpage;
obtaining a plurality of first fields according to the first form by the processor;
obtaining, by the processor, a rule corresponding to each first field according to the first form obtained from the structured language that describes the webpage to create a first slot filling model, wherein the rule includes at least one of the following: a type, an attribute, and an option;
generating the conversational user interface by the processor; and
performing syntax matching, type matching, attribute matching and option matching according to a user input dialogue data received by the processor to obtain data that can be filled in the plurality of first fields;
wherein the processor is configured to use the first slot filling model to determine data required by the plurality of first fields, and automatically obtain data that can be filled in the plurality of first fields.

2. (canceled)

3. The method for generating the conversational user interface according to claim 1, wherein the first slot filling model is configured to analyze content of the input dialogue data to obtain at least one word, and compare the at least one word with the rule of each first field to fill in the plurality of first fields.

4. The method for generating the conversational user interface according to claim 1, further comprising:
analyzing, by the processor, each first field according to the webpage to determine at least one of the type, the attribute, and the option corresponding to each first field, so as to create the rule.

5. The method for generating the conversational user interface according to claim 1, further comprising:
creating, by the processor, the rule by training log data, wherein the log data is related to accessing the first form.

6. The method for generating the conversational user interface according to claim 1, further comprising:
determining an update section of the rule when the webpage is updated at a scheduled time, wherein the update section of the rule is at least one of the type, the attribute, and the option; and
storing the update section of the rule in a data file.

7. The method for generating the conversational user interface according to claim 6, wherein the processor is configured to:
read the data file;
update the rule of each first field according to the data file; and
analyze content of the input dialogue data to obtain at least one word, and compare the at least one word with the rule of each first field to fill in the plurality of first fields.

8. (canceled)

9. The method for generating the conversational user interface according to claim 1, further comprising:
obtaining, by the processor, a first function corresponding to the first form;
wherein the processor is configured to determine a user intention according to the input dialogue data, and when the user intention is corresponding to the first function, the processor uses the first slot filling model to obtain data that can be filled in the plurality of first fields according to the user input dialogue data to fill in the plurality of first fields.

10. The method for generating the conversational user interface according to claim 1, wherein the processor is configured to display a confirmation message on the conversational user interface after obtaining the data that can be filled in the plurality of first fields, and generate a corresponding API according to the data that can be filled in the plurality of first fields and the webpage after the confirmation message is confirmed, so as to send the API to a website corresponding to the webpage.

11. A system for generating a conversational user interface, the system comprising a processor to execute the following modules:
a webpage extraction module, configured to extract content of a webpage;
a webpage analysis module, configured to obtain a first form in the webpage by parsing a structured language that describes the webpage and obtain a plurality of first fields according to the first form; and
a model building module, configured to obtain a rule corresponding to each first field according to the first form obtained from the structured language that describes the webpage to create a first slot filling model and generate the conversational user interface;
wherein the model building module is configured to perform syntax matching, type matching, attribute matching and option matching according to an user input dialogue data to obtain data that can be filled in the plurality of first fields.

12. (canceled)

13. The system for generating the conversational user interface according to claim 11, wherein the first slot filling model is configured to analyze content of the input dialogue data to obtain at least one word, and compare the at least one word with the rule of each first field to fill in the plurality of first fields.

14. The system for generating the conversational user interface according to claim 11, wherein the webpage analysis module is configured to analyze each first field according to the webpage to determine at least one of the type, the attribute, and the option corresponding to each first field, so as to create the rule.

15. The system for generating the conversational user interface according to claim 11, further comprising:
a syntax training module, for creating the rule by training log data, wherein the log data is related to accessing the first form.

16. The system for generating the conversational user interface according to claim 11, further comprising a data update module, the data update module configured to:
extract the webpage again to determine an update section of the rule; and
store the update section of the rule in a data file.

17. The system for generating the conversational user interface according to claim 16, wherein the model building module is configured to:
read the data file;
update the rule of each first field according to the data file; and
analyze content of the input dialogue data to obtain at least one word, and compare the at least one word with the rule of each first field to fill in the plurality of first fields.

18. (canceled)

19. The system for generating the conversational user interface according to claim 11, wherein the webpage analysis module is configured to obtain a first function corresponding to the first form;
wherein the model building module is configured to determine a user intention according to the user input dialogue data, and when the user intention is corresponding to the first function, the model building module uses the first slot filling model to obtain data that can be filled in the plurality of first fields according to the input dialogue data to fill in the plurality of first fields.

20. The system for generating the conversational user interface according to claim 11, wherein the model building module is configured to display a confirmation message on the conversational user interface after obtaining the data that can be filled in the plurality of first fields, and generate a corresponding API according to the data that can be filled in the plurality of first fields and the webpage after the confirmation message is confirmed, so as to send the API to a website corresponding to the webpage.
